(19) United States
(12) Patent Application Publication
(10) Pub. No.: US 2026/0168910 A1
(43) Pub. Date: Jun. 18, 2026

(54) CYCLIC POLYMER PROCESSING METHOD INCLUDING AN INLINE VISCOSITY MEASUREMENT METHOD

(71) Applicant: Promix Solutions AG, Winterthur (CH)

(72) Inventor: Rolf Heusser, Winterthur (CH)

(73) Assignee: Promix Solutions AG, Winterthur (CH)

(21) Appl. No.: 19/418,423

(22) Filed: Dec. 12, 2025

(30) Foreign Application Priority Data
Dec. 14, 2024 (EP) 24220017.8
Aug. 11, 2025 (EP) 25195056.4
Oct. 22, 2025 (EP) 25210532.5

(51) Int. Cl. G01N 11/08; B29C 45/76

(52) U.S. Cl. CPC G01N 11/08; B29C 45/7646; B29C 2945/7605; B29C 2945/76354; B29C 2945/76381

(57) ABSTRACT

The invention relates to a cyclic polymer processing method comprising an inline viscosity measurement method for determining a viscosity measurement value of a fluid polymer stream. The fluid polymer stream flows through a measuring section arranged in a closed channel, in which at least one static mixer containing a built-in element is arranged, whereby an inlet pressure upstream of the built-in element and an outlet pressure at an outlet end are measured. A computer unit determines a pressure difference between the inlet pressure and the outlet pressure. The maximum measured pressure difference during a measurement time per cycle is at least 5 bar.

### CROSS-REFERENCE TO RELATED APPLICATIONS

This application claims priority to European patent application no. EP 24220017.8, filed Dec. 14, 2024, European patent application no. EP 25195056.4, filed Aug. 11, 2025, European patent application no. EP 25210532.5, filed Oct. 22, 2025, the content of all of which are hereby incorporated by reference in their entirety.

### BACKGROUND

The invention relates to a cyclic polymer processing method including an inline viscosity measurement method for measuring the viscosity of a polymer. The invention relates in particular to the use of the inline viscosity measurement method in a cyclic polymer processing method for polyester. The inline viscosity measurement method can be used to determine a signal that correlates with or can be derived from a viscosity measurement value obtained from the measurement.

A cyclic polymer processing method is understood to be a polymer processing method in which the flow rate of the polymer varies periodically. A subgroup of cyclic polymer processing methods is referred to in this application as discontinuous polymer processing methods. In this application, a discontinuous polymer processing method is defined as a cyclic polymer processing method in which no processing of the polymer takes place during part of the cycle time. In other words, in a discontinuous polymer processing method, polymer is only conveyed during another part of the cycle duration. For example, a cyclic polymer processing method includes an injection molding method. Injection molding methods have been used for decades to manufacture plastic articles.

Polyester, such as polyethylene terephthalate (PET), is a widely used class of plastic materials with very good properties. In this application, polyester refers to polymers with ester functions in the main chain. These include thermoplastic polyethylene terephthalate (PET), thermoplastic polyester elastomers (TPC), polybutylene terephthalate (PBT), and thermoplastic polycarbonates (PC). Polyesters are not easy to process because they are very sensitive to moisture and, as polymers, they also decompose easily when processed in a molten state. Polyesters can also be returned to the process cycle as recyclates. Accordingly, it is important to continuously monitor the quality during the processing of polyester and, if necessary, to influence the quality.

### DESCRIPTION OF RELATED ART

Known viscosity measuring devices for online measurement of the viscosity of polymers are configured in such a way that the viscosity of the polymer can be determined by means of a pressure difference across an orifice or a capillary. In addition to such online measurements, it is also possible to take a polymer sample from a process and examine it in a laboratory. However, laboratory testing is not suitable for online monitoring, control, or regulation of the process, as the measurement result is only available at a much later point in time, which means that it is no longer possible to influence the viscosity of the polymer. For this reason, the previously known viscosity measurement method was developed, which works as follows: a side stream is diverted from the polymer stream and the viscosity of the side stream is determined by means of a pressure difference across the orifice or capillary through which the side stream is passed. However, this previously known viscosity measurement method has various disadvantages. The viscosity in the side stream is not representative of the polymer stream. Due to the low flow rate volumes in the side stream, orifices or capillaries with very small diameters are required. However, these orifices or capillaries can be prone to clogging, especially when processing polymer recyclates.

For the reasons mentioned above, the viscosity of polymers cannot be measured reliably using conventional viscosity measuring devices. Therefore, a viscosity measurement value obtained using the known viscosity measuring device cannot be used as a signal for controlling a parameter that influences viscosity and thus cannot be used to control or monitor the quality of the polymer being processed using the processing method. In other words, due to the inherent fluctuation range of the signal obtained with the known viscosity measuring device, controlling the quality of the polymer based on this signal is too unreliable in practice and therefore impractical.

A continuously flowing fluid polymer stream is required for viscosity measurement using an orifice or capillary. In cyclic processing methods, the polymer stream also varies. For cyclic polymer processing methods, it has proven difficult in the past to divert a stable, constant side stream for viscosity measurement for the reasons mentioned above. In addition, only the viscosity in a small side stream is measured, so the viscosity measurement obtained is not representative of the polymer flow. The viscosity measuring devices available on the market are also very expensive, as they require an additional side stream pump to convey the side stream.

For a production plant for manufacturing thermoplastic material, a method for control and/or regulation was therefore provided in accordance with the teaching of EP 3 579 069 A1, which detects a pressure value in the production plant, determines an estimated value for the viscosity based on the recorded pressure measurement value and a temperature dependence of the viscous behavior of the thermoplastic material and the volume flow, and determines a viscosity value indicative of the viscous behavior of the thermoplastic material as a function of a correction factor for a plant state. The plant condition is determined by at least one production parameter. The pressure measurement value is determined as the pressure difference between a first pressure and a second pressure. The pressure difference is determined in particular in a fluid section, whereby the first pressure is measured upstream of the static mixer and the second pressure is measured downstream of the static mixer. The thermoplastic material is produced continuously. The pressure differences can be measured continuously and/or discretely at predetermined time intervals. Since the process is used to produce a precisely specified plastic, i.e., virgin material, the viscosity can be reliably controlled by using historical values or entering a target viscosity. However, this process fails in cases where polymers of different, sometimes unknown compositions have to be processed, especially for the processing of polymer recyclates. An estimated value for viscosity, especially during product changes based on historical values, can only be used if the properties of the plastic to be produced are known from the literature. However, this method cannot be used for a polymer processing method for an unknown polymer or polymer mixture, which in particular contains polymer recyclate, for which such historical values are not available. In addition, the thermoplastic is produced continuously and a flow rate and a pressure difference measured from this via the static mixer is given at all times. The process described is not applicable in this way to a cyclic polymer processing method.

A method for determining a consistency index (k) and a power law index (n) of a Newtonian or non-Newtonian fluid exhibiting power law behavior is known from document U.S. Pat. No. 6,412,337 B1. The fluid to be determined flows in laminar flow through a pipe in which a first static mixer and a second static mixer are arranged, which differ geometrically from each other and accordingly exhibit different pressure differences.

Such non-Newtonian fluids often contain high proportions of solid particles in the range of 0.1 to 5.0 mm. These solid particles can accumulate on conventional viscometers or migrate from walls, requiring frequent cleaning. This problem does not occur with low-viscosity fluids, but the pressure differences are often too low to be correctly recorded in measuring arrangements such as those described in U.S. Pat. No. 4,680,957 A. For pressure differences of around 100 Pa, the solution described in U.S. Pat. No. 6,412,337 B1 is recommended, which involves two static mixers connected in series in a pipe. If the viscosity is to be measured throughout the entire processed flow, it is generally advantageous to keep the pressure difference as low as possible, as disclosed in document U.S. Pat. No. 6,412,337 B1. Higher pressure differences lead to higher pressure build-up in the conveying device, such as the extruder or a pump. This requires more energy when processing the entire material flow and increases the risk of thermal damage to the processed product due to the increased heat input. However, practical experience, especially in the processing of viscous polymers, has shown that inline viscosity measurement of the entire polymer flow becomes very inaccurate at low differential pressures. It has been found that the measured pressures vary over time due to slight fluctuations in polymer flow rate, distorting the measurement result. The measured pressure fluctuations are attributed to slight flow rate fluctuations of the conveying device, such as the extruder or pump, as well as a certain compressibility of the polymer. The measurement results were particularly inaccurate and, in some cases, meaningless in discontinuous processes, as the time in a cycle is insufficient to achieve a stable, reproducible measurement.

It is known that viscosity can be measured continuously in a continuous polymer processing method. In a continuous polymer processing method with bypass, a small portion of the main flow is diverted via a pump as a side flow, and the pressure difference is measured in this side flow via an orifice. Static mixers are also known, which are installed in the main flow in a continuous polymer processing method and via which the pressure difference is measured. The viscosity and shear can be determined from the measured pressure difference and the measured flow rate, which can be measured as volume flow or mass flow. A viscosity measurement for plastic melts is only meaningful if the measured viscosity can also be assigned to a shear. This is important for plastic melts because the measured viscosity depends on the shear. By assigning the shear to the measured viscosity, process-independent parameters, i.e., those that depend only on the plastic, such as the intrinsic viscosity (IV) for polyester melts or a melt flow index (MFI/MFR), can be determined. These process-independent parameters can be used to assess the quality of the plastic independently of the process conditions, which is particularly important for the processing of recyclates.

To date, it has not been possible to reliably measure viscosity inline during an injection molding process and thus assign a viscosity and, in particular, a process-independent viscosity parameter to each molded plastic part.

The main problem is that a stable flow rate is required for continuous inline viscosity measurement. This is particularly important if a process-independent viscosity parameter is to be determined, which can then also be used optionally for controlling a process parameter. However, a stable flow rate is not available in a cyclic polymer processing method, especially an injection molding process, since the flow rate only exists for a very short time in a cycle. For example, if the measuring point is located in the outlet region of an injection molding machine, there is only a flow rate during the injection of the polymer melt into the molding tool. If the measuring point is located between the extruder and a storage container that temporarily stores the polymer melt before injection, there is only one flow rate during the filling of this storage container. The duration of the flow rate in a cycle is in the range of 0.5 to 10 seconds. If a measuring point is located in the outlet region of an injection molding machine, the cycle corresponds to the injection time. If a measuring point is located between an extruder and a storage container, the cycle corresponds to the filling time for the storage container. The storage container can be configured as an intermediate storage container. During this short period of time, the effective flow rate also varies. The polymer melt is conveyed under very high conveying pressure, typically from 100 bar to over 2000 bar. After completion of the conveying operation, the conveying pressure usually drops to a few bar. This massive pressure surge load leads to alternating compression and relaxation of the polymer melt because the polymer melt is compressible at the aforementioned conveying pressures. In addition, at these conveying pressures, the closed channel containing the polymer melt, which is usually configured as a steel housing, also expands, which further intensifies the compression and relaxation as a pumping effect.

For these reasons, it has not yet been possible to implement an inline viscosity measurement method for a cyclic polymer processing method.

It is an object of the invention is to provide a reliable, i.e., accurate, simple, and cost-effective cyclic polymer processing method that uses an inline viscosity measurement method to reliably measure the quality of a viscous polymer during its processing. In particular, the object of the invention is to directly influence and control the quality of the polymer by means of suitable measures in the polymer processing method. A further object of the invention is to provide a cyclic polymer processing method with a sustainable viscosity measurement method in which no losses of the polymer to be processed occur.

An object of the invention is to provide a cyclic polymer processing method with a reliable inline viscosity measurement method, in particular for an injection molding process for processing plastics. Since recyclates are increasingly being used in injection molding, a further object is to provide a cyclic polymer processing method that includes an inline viscosity measurement method that allows conclusions to be drawn about the quality of the plastic, in particular for recyclates.

### SUMMARY OF THE INVENTION

The invention is achieved by means of a cyclic polymer processing method according to claim 1. Advantageous method variants are the subject of the dependent claims.

When the term “for example” is used in the following description, this term refers to examples of embodiments and/or variants, which should not necessarily be understood as a preferred application of the teaching of the invention. Similarly, the terms “preferably” and “preferred” should be understood as referring to one example from a set of embodiments and/or variants, which should not necessarily be understood as a preferred application of the teaching of the invention. Accordingly, the terms “for example,” “preferably,” or “preferred” may refer to a plurality of embodiments and/or variants.

The following detailed description contains various examples of embodiments of the cyclic polymer processing method according to the invention. The description of a specific cyclic polymer processing method should only be regarded as an example. In the description and claims, the terms “contain,” “comprise,” and ‘have’ are interpreted as “contain, but are not limited to.”

In this application, a viscous polymer is understood to be a polymer whose viscosity under processing conditions in a static mixer is in the range of 50 Pas to 10,000 Pas.

In this application, the quality of the polymer is understood to be a parameter that characterizes the chain degradation of the polymer when a polymer is processed in which chain degradation reduces the quality of the polymer. Thermal stress on the polymer and the effect of shear forces on the polymer can cause chain degradation, which leads to a reduction in the viscosity of the polymer. Chain degradation therefore correlates with the viscosity measurement value obtained. If the inline viscosity measurement method determines that the viscosity measurement value is too low, a loss in polymer quality due to chain degradation can be determined, which can result in reduced quality of the processed product obtained by the cyclic polymer processing method.

A viscosity measurement value can be understood as a viscosity that depends on temperature and flow rate. A viscosity measurement value can also be understood as an intrinsic viscosity that is independent of flow rate and temperature. A viscosity measurement value can also be understood as a viscosity measurement point that is determined at a specific temperature and a specific shear rate. The viscosity measurement point can be used to determine a measured value for characterizing the flow behavior of the polymer. The measured value can, for example, be selected from the group consisting of the melt mass flow ratio (MFR), melt mass flow index (MFI), melt volume flow ratio (MVR), or melt volume index (MVI). These measured values are measured in accordance with DIN standard DIN EN ISO 1133/1133-1 and 1133-2.

A cyclic polymer processing method according to the invention can also be used for moisture-sensitive polymers, in particular polyesters. When a moisture-sensitive polymer is processed using a cyclic polymer processing method, moisture can lead to chain degradation, whereby the chain degradation leads to a reduction in the viscosity measurement value.

The invention provides a highly accurate, reliable, simple, and cost-effective cyclic polymer processing method, whereby a viscosity measurement value is determined directly in the process stream during the polymer processing method, i.e., an inline viscosity measurement method is used. The viscosity measurement value can be used to control at least one parameter that influences the viscosity measurement value. In other words, the viscosity measurement value can be changed by means of the parameter. The parameter can be, for example, an addition of additives. Additives can include chain extenders or water, for example. If necessary, the viscosity measurement value can also be used to determine process-independent raw material parameters that can provide information about the quality of the raw material. One example of a raw material parameter is the melt flow rate (MFR). The melt flow rate is a measure of the flowability of molten plastic and is a typical index for quality control of thermoplastic materials. Another raw material parameter of polyester materials is their intrinsic viscosity (IV). The IV of PET, for example, is measured by dissolving the PET in phenol-1,2-dichlorobenzene at 132° C. and then measuring and calculating the viscosity of the solution at 25° C. using a Ubbelohde viscometer in accordance with ISO standard 1628. Another raw material parameter is the relative viscosity (RV) for polyamides. The RV of polyamides is measured, for example, by dissolving the polyamide in 96% sulfuric acid at a concentration of 0.01 g/ml at 20° C. and then measuring and calculating the viscosity of the solution with an Ubbelohde viscometer in accordance with ASTM D0789-19. For the present description of the invention, the term “raw material parameters” is used for the above examples.

The cyclic polymer processing method according to the invention, comprising an inline viscosity measurement method for measuring the viscosity of a fluid polymer stream, is carried out in a closed channel. The fluid polymer stream flows through a measuring section arranged in the closed channel, wherein the closed channel comprises a longitudinal axis, an inlet end, and an outlet end. The measuring section extends at least between the inlet end and the outlet end, with at least one built-in element arranged in the measuring section so that a static mixer is formed by the measuring section. A static mixer is thus arranged in the measuring section. The static mixer contains at least one flow-splitting mixing element. The flow-splitting mixing element can be configured as a built-in element. The built-in element can comprise, in particular, a first built-in element and a second built-in element. The static mixer can contain at least a first built-in element and a second built-in element. An inlet pressure is measured upstream of the built-in element by an inlet pressure sensor, so that an inlet pressure measurement value is obtained, and an outlet pressure is measured downstream of the flow-splitting mixing element by an outlet pressure sensor, so that an outlet pressure measurement value is obtained. The inlet pressure is measured upstream of the first built-in element and second built-in element by an inlet pressure sensor, so that an inlet pressure measurement value is obtained, and an outlet pressure can be measured downstream of the first built-in element and second built-in element by an outlet pressure sensor, so that an outlet pressure measurement value is obtained. The inlet pressure measurement value and the outlet pressure measurement value are converted by means of a transducer into measurement variables that can be processed by a computer unit. The computer unit determines a pressure difference between the inlet pressure measurement value and the outlet pressure measurement value. The flow rate of the fluid polymer stream is determined by means of a conveyor or a flow rate measuring device, whereby the viscosity is determined as a viscosity measurement value using a calculation formula based on the pressure difference of the fluid polymer stream and the flow rate of the fluid polymer stream, whereby the fluid polymer stream is not a side stream with recirculation, so that the fluid polymer stream is mixed using the static mixer. The maximum measured pressure difference during a measurement time per cycle is at least 5 bar.

Surprisingly, it has been shown that inline viscosity measurement is possible in a cyclic polymer processing method. The entire fluid polymer stream is passed through a static mixer; in other words, a static mixer is installed in the closed channel through which the entire fluid polymer stream flows as the main stream. The closed channel can be located in the outlet region of an injection molding machine or between an extruder and an intermediate storage container. It has been shown that, despite the very short measurement time during a cycle, reproducible pressure differences can be measured if the pressure difference is at least 5 bar. A cycle corresponds to the time during which the fluid polymer stream flows. In particular, the maximum measured pressure difference can be in a range of at least 5 bar and up to and including a maximum of 50 bar.

It has been found that, at pressure differences below 5 bar, the measurement signal and thus the viscosity measurement are significantly distorted by the compression and decompression of the melt, the expansion of the steel pipes, and sensor inaccuracies.

Melt pumps are not normally used in cyclic polymer processing. This means that flow rate cannot be determined using pump speed. The speed of a screw conveyor is also unsuitable for measuring flow rate, as the screw conveyor is often moved axially in the direction of conveyance during polymer processing, which would influence the flow rate measurement. In simple injection molding machines without an intermediate storage container, viscosity measurement can be performed when the melt is injected into the molding tool. The measuring section is located in particular at the outlet of the injection molding machine.

According to an embodiment, a displaced volume can be determined via a conveying speed of a conveyor screw, or the displaced volume can be measured in an intermediate storage container, or the displaced volume can be determined from the weight of a component manufactured in a cycle. For this purpose, a filling time for filling an intermediate storage container can be measured, or an injection time for injecting the fluid polymer stream into a molding tool can be measured. The flow rate can be determined from the displaced volume and the filling time or the injection time. In particular, the weight can be the total weight of the component, whereby the total weight can be obtained by weighing the component.

The displaced volume during injection, enabled by the axial displacement of the conveyor screw, and the injection time can be used to determine the flow rate and the shear in particular.

In injection molding machines with intermediate storage container, viscosity measurement can also be performed optionally between the extruder and the intermediate storage container. The measurement is performed while filling the intermediate storage container. The flow rate and shear can be determined by measuring the storage cylinder filling time and the filling volume in the intermediate storage container. The intermediate storage container is usually a container that contains a piston that can be moved axially so that the filling volume can be changed, as with a syringe. Alternatively, the intermediate storage container can also be designed as a second extruder, in which the filling volume can be changed by axially moving the extruder's conveyor screw.

It has been shown that a start ramp at the beginning of the conveyance and a stop ramp at the end of the conveyance can be neglected, since the start ramp and the stop ramp are usually small in relation to the total conveyance time. It has also been shown that it is sufficient to determine a mean shear per cycle calculated in this way if the effective speed varies during conveyance. The measured pressure difference is advantageously either an average value over the entire conveyance time or the measured maximum value per cycle, which can involve a slight distortion. The conveyance time corresponds to the measurement time, as the measurement can only be performed when conveyance is taking place. The cycle time corresponds to the total duration of the cycle, i.e., the sum of the pumping time and the time during which no pumping takes place. In this way, together with a temperature measurement, a viscosity in Pas, a corresponding shear, and process-independent viscosity parameters can be determined for each injection cycle, even in an injection molding process.

According to an embodiment, the viscosity measurement value is determined between an extruder and an intermediate storage container.

In particular, the flow rate of the fluid polymer stream can vary over time during the measurement.

According to an embodiment, the viscosity measurement value is controlled by adding additives. According to an embodiment, the viscosity measurement value is used to determine a signal that correlates with the viscosity measurement value.

In particular, a control method using the signal as an input variable can be used to control a parameter that changes the viscosity of the fluid polymer stream. The parameter can in particular comprise a chain extension additive. The parameter can in particular comprise an additive which contains water or can split off water. According to an embodiment, the parameter is a melting temperature if the fluid polymer stream is configured as a polymer melt.

In particular, a statement regarding the plastic quality can be obtained by means of a process-independent viscosity measurement value such as intrinsic viscosity (IV) or MFI/MFR. At least one process parameter can be controlled using the viscosity measurement values, in particular process-independent viscosity parameters. The process parameter can be, for example, the amount of another plastic raw material with a different viscosity added, an adjustment of the melt temperature, or an addition of chain extender additives.

According to an embodiment, the measurement time per cycle is less than 10 seconds. In particular, the measurement time per cycle can be less than 5 seconds.

According to an embodiment, the built-in element is configured as at least one group of web elements. The at least one group of web elements extends in a first group plane and a second group plane, wherein the first group plane includes a first angle to the longitudinal axis of the closed channel and the second group plane includes a second angle to the longitudinal axis of the closed channel. The first group plane intersects with the second group plane.

According to an embodiment, the temperature of the fluid polymer stream can be determined using a temperature sensor, whereby the temperature is determined at a temperature measuring point. The temperature measuring point is selected such that the measured temperature is representative of the temperature of the fluid polymer stream in the closed channel.

It has been shown that viscosity measurement becomes significantly more accurate at pressure differences of at least 5 bar, as the basic fluctuations in the polymer processing method are surprisingly dampened. The negative effects of product decomposition at higher pressure differences could be kept to a minimum, in particular by choosing a static mixer with cross-wise arranged we elements, as the residence time distribution could be kept low in this static mixer.

Especially when the composition of the polymer is unknown, the inline viscosity measurement method according to the invention can be used to reliably obtain a viscosity measurement value in a cyclic polymer processing method. In other words, the entire fluid polymer stream produced in a polymer processing method is used to perform the inline viscosity measurement method according to the invention. No side stream with or without recirculation needs to be branched off to perform the inline viscosity measurement method. The inline viscosity measurement method therefore does not produce any waste material, meaning that the inline viscosity measurement method according to the invention ensures the best possible utilization of the scarce resource of polymer. Surprisingly, the implementation of the inline viscosity measurement method according to the invention is more sustainable than the use of previously known viscosity measurement methods, even though the measurement is carried out in the entire polymer stream produced by means of the polymer processing method. Since the viscosity measuring device has no disruptive influence on the fluid polymer stream, particularly due to the use of the static mixer, the entire fluid polymer stream can be further processed in subsequent processing steps without waste to a product whose quality can also be maintained at a consistently high level using the inline viscosity measurement method.

A static mixer is defined as a device that contains at least one built-in element by means of which the fluid polymer stream is mixed by forming and rearranging layers. The fluid polymer stream is guided through the static mixer at least in the region of the measuring section. Surprisingly, the use of the static mixer for the entire fluid polymer stream also makes it possible to improve the quality of the polymer processed in the polymer processing method. In particular, a polymer mixture, for example a polymer recyclate, can be processed, which was previously not possible in satisfactorily reproducible quality due to the lack of viscosity information. For example, additives can be optimally dosed into the fluid polymer stream based on the viscosity measurement value obtained using the inline viscosity measurement method, and these additives can be mixed directly with the fluid polymer stream via the static mixer. The static mixer thus produces a homogeneous fluid polymer stream. The homogeneous fluid polymer stream can have a viscosity measurement value that is constant in relation to the cross-section of the closed channel. In other words, the homogeneity of the fluid polymer stream obtained by means of the static mixer means that the same viscosity measurement value can be obtained at every point of the cross-section of the closed channel, with the exception of wall areas. The constant viscosity measurement value thus provides a basis for a particularly reliable measurement result. This surprising effect can only be achieved if the static mixer is located in the fluid polymer stream used in the polymer processing method for manufacturing the processed product. Such an effect cannot be achieved with a previously known viscosity measuring device, as there is no mixing of the fluid polymer stream. Therefore, the previously known viscosity measuring device, as described for example in document EP 3 579 069 A1, was only used for the production of new polycarbonate. For the inline viscosity measurement method according to the invention, the fluid polymer stream can comprise a polymer melt, a only partially polymerized polymer, a polymer in solution, or a plastic melt, which can in particular contain a mixture of different polymers. The fluid polymer stream can contain in particular a polymer recyclate.

According to this embodiment, the pressure difference is measured via the static mixer. The viscosity value is determined using the calculation formula with the additionally determined flow rate and temperature. Process-independent raw material parameters can be determined using the viscosity value.

The calculation formula for the viscosity measurement value can be as follows, for example: The viscosity measurement value corresponds to the pressure difference multiplied by the cross-sectional area of the static mixer in relation to the flow rate and the length of the static mixer. Flow rate refers to the fluid polymer stream passing through the closed channel per unit of time. The fluid polymer stream can be determined as mass flow in [kg/s] or as volume flow in [m³/s]. The closed channel is characterized by its inner diameter and the measuring distance. The measuring section can correspond in particular to the channel length. The viscosity measurement value is determined using a calculation formula based on the determined pressure difference, the temperature of the fluid polymer stream, and the flow rate of the fluid polymer stream.

The viscosity measurement value can in particular comprise a measurement value from the group consisting of a viscosity and an intrinsic viscosity. In particular, an intrinsic viscosity can be determined using the inline viscosity measurement method according to the invention. The viscosity measurement value can be used to determine a signal that correlates with the viscosity measurement value. According to an embodiment, an intrinsic viscosity is derived from the pressure difference.

The viscosity measurement value for a specific static mixer can be determined by introducing a mixer index KM, a constant, as follows:

$$viscosity measurement value = Δ p \times {( {d}_{M} )}^{2} / ( KM \times v \times LM )$$

where Δp denotes the pressure difference, d_{M} denotes the inner diameter of the static mixer, KM denotes the mixer index of the static mixer, v denotes the flow rate, and LM denotes the mixer length.

The conveying device can comprise at least one conveying device from the group consisting of a melt pump and an extruder. According to an embodiment, the flow rate is determined via the rotational speed of a melt pump. According to an embodiment, there is a distance between the outlet of the melt pump and the inlet end of the closed channel, whereby the distance corresponds to a maximum of five times the inner diameter of the closed channel.

Since the entire fluid polymer stream is passed through the static mixer, it can be ensured that the viscosity measurement obtained is representative of the entire fluid polymer stream. Since the entire fluid polymer stream is passed through the static mixer, a static mixer of any size can be used. The static mixer can comprise at least a first built-in element and a second built-in element, wherein the first built-in element is spaced apart from a channel wall of the closed channel or the at least one second built-in element in such a way that a gap is formed between the first built-in element and the second built-in element or the first or second built-in element and the channel wall, so that a blockage in the measuring section due to clogging can be prevented. The static mixer can be adapted in particular to the use of polymers with fillers. The static mixer can also be adapted for use with polymer recyclate. The inline viscosity measurement method according to the invention, which includes the static mixer, has proven to be very stable and forms an ideal basis for determining the quality of the polymer. The quality of the polymer can be adjusted, for example, by adding additives.

According to an embodiment, the built-in element is configured as at least one web element, wherein the web element protrudes into the closed channel with a web element length LS that corresponds to at least 25% of the diameter DS of the closed channel.

The built-in element is designed as at least one group of web elements. The at least one group of web elements extends in a first group plane and a second group plane, wherein the first group plane forms a first angle with the longitudinal axis of the closed channel and the second group plane forms a second angle with the longitudinal axis of the closed channel. The first group plane intersects with the second group plane. In particular, at least one of the first angle and the second angle measured relative to the longitudinal axis can have a value other than 90 degrees. The first group plane and the second group plane each contain, for example, at least one web element. According to an embodiment, the built-in element contains at least one set of intersecting web elements. The set contains at least two groups of web elements arranged at the same angle to the flow direction. Each of the at least two groups can have an angle unequal to 90 degrees to the flow direction. According to an embodiment, the web elements of the at least two groups intersect. According to an embodiment, a plurality of groups of web elements are arranged one after the other in the measuring section. In particular, at least some of the web elements can be connected to the closed channel in such a way that at least some of the web element ends are not connected to the closed channel. In other words, at least some of the web elements can have at least one web element end that is not connected to an inner wall of the closed channel.

It has been shown that the static mixer, particularly in an embodiment comprising a group of web elements in a first group plane and a second group plane, wherein the first group plane forms a first angle with the longitudinal axis of the closed channel and the second group plane forms a second angle with the longitudinal axis of the closed channel, for example with intersecting web elements, is advantageously designed such that the measurement is performed with a shear rate in the range from 20 [1/s] up to and including 500 [1/s]. In other words, a shear rate in the range of 20 [1/s] up to and including 500 [1/s] is generated for the measurement when the fluid polymer stream flows through the static mixer.

In this region, reproducible and very stable measurements over time were achieved using the static mixer. It has been shown that at shear rates below 20 [1/s], deposits form in the static mixer and the polymer, especially polyester or a polymer recyclate and particularly polyester with recyclate components, decomposes. This decomposition produces decomposition products which form deposits in known polycarbonate production plants. Such deposits lead to errors in viscosity measurement, as part of the pressure difference cannot be attributed to the viscosity of the polymer, but is caused by the narrowing of the channel due to the deposits. According to the invention, these deposits can surprisingly be avoided when using polymer recyclates. On the one hand, the viscosities of polymer recyclates are very low due to partial polymer chain degradation. In order to achieve reproducible and accurate viscosity measurements, static mixers with relatively high flow resistances and pressure differences and a correspondingly large number of relatively densely packed internal components are required. Polymer recyclates can also contain foreign particles and/or solids, which can lead to deposits or blockages in complex, densely packed internal components, resulting in inaccurate measurement results. Surprisingly, it has been found that static mixers having built-in elements that are configured as a group of web elements, wherein the at least one group of web elements extends in a first group plane and a second group plane, wherein the first group plane includes a first angle to the longitudinal axis of the closed channel and the second group plane includes a second angle to the longitudinal axis of the closed channel, have been shown to produce very good measurement results despite the relatively dense packing of web elements. In tests, no deposits and/or measurement errors were detected even after prolonged periods of operation. Built-in elements in which at least two groups of web elements, in particular parallel web elements, intersect at an angle of 25 to 60 degrees inclusive have proven particularly effective. A group of web elements can, for example, comprise 4 to 12 web elements arranged next to each other.

In test series with polyesters containing recycled material, temporal fluctuations in the pressure difference were observed at shear rates below 20 [1/s]. These temporal fluctuations are due to uneven flow through the static mixer and very small measured pressure differences. Temporal fluctuations in the pressure difference are particularly disruptive when the viscosity and, in particular, the intrinsic viscosity are regulated, for example by adding an additive. At shear rates greater than 500 [1/s], the channel cross-section of the closed channel through which the fluid polymer stream passes, in which the static mixer is located, becomes very small in relation to the channel cross-section of the inlet and outlet of the measuring section. This can lead to blockages, especially when using polyester with recycled content. A transition region between the inlet and outlet to the measuring section containing the static mixer can be configured as a conical section. Deposits can occur in the conical section, which have a negative effect on the dwell time behavior.

According to an embodiment, the closed channel has an inner diameter, with at least one of the web elements having a web element length LS that is greater than the inner diameter. In particular, according to an embodiment, at least some of the web elements can be connected to the closed channel in such a way that at least some of the web elements, in particular end regions of the web elements, are not connected to the closed channel.

According to an embodiment, the viscosity measurement value is used to determine a signal that correlates with the viscosity measurement value. In particular, a control method using the signal as an input variable can be used to control a parameter that changes the viscosity of the fluid polymer stream. The parameter can in particular comprise a chain extension additive. The parameter can in particular comprise an additive which contains water or can split off water. According to an embodiment, the parameter is a melting temperature if the fluid polymer stream is configured as a polymer melt.

According to an embodiment, the viscosity measurement value can be configured as a process-independent viscosity measurement value. The term “process-independent viscosity measurement value” refers in particular to the fact that the viscosity measurement value is independent of the flow rate and temperature of the fluid polymer stream. The process-independent viscosity measurement value can be used to generate a process-independent signal for controlling the polymer processing method. For example, a process-independent viscosity measurement value can be used to filter out changes in the viscosity measurement value that are due to a change in the temperature or flow rate of the fluid polymer stream. According to this embodiment, the process-independent viscosity measurement value performs a filter function for undesirable parameters that should not be included in the control. Without this filter function, viscosity measurement values can also contain influences that are due to a change in the temperature or flow rate of the fluid polymer stream. Such viscosity measurements can result in an erroneous signal, meaning that the control process would use the erroneous signal as an input variable to control a parameter that would change the viscosity measurement of the fluid polymer stream in an impermissible manner.

According to an embodiment, the temperature of the fluid polymer stream is determined by means of a temperature sensor, whereby the temperature can be determined at a temperature measuring point. In particular, the temperature measuring point can be selected such that the measured temperature is representative of the temperature of the fluid polymer stream in the closed channel.

The polymer can comprise, for example, a polyester or a polyamide. In particular, the cyclic polymer processing method can be used to produce a polyester containing a portion of polyester recyclate. In cyclic polymer processing methods, the maximum measured pressure difference should be at least 5 bar in each cycle. In particular, the cyclic polymer processing method can be carried out discontinuously. A discontinuous polymer processing method is understood to be a cyclic polymer processing method in which the flow rate is zero during part of the cycle, in other words, no polymer is conveyed. For each cyclic polymer processing method, the flow rate of the fluid polymer stream can vary over a period of time during measurement.

Examples of cyclic polymer processing methods include injection molding and extrusion blow molding. In cyclic polymer processing methods, the fluid polymer stream is not constant over time, but can vary or even be interrupted at times. The inline viscosity measurement method according to the invention has proven to be ideal for measuring viscosity in cyclic polymer processing methods. The measurement is very stable and reacts immediately to fluctuations in flow rate, which is crucial for continuous measurement. The highest measured flow rate and the highest measured pressure difference per cycle can be used as a basis for determining the viscosity measurement value for the cyclic polymer processing method. The highest measured flow rate and the highest measured pressure difference are considered to be an average value of the highest 0-10% of the measured values for the flow rate and the pressure difference. Alternatively, the measured flow rate and the measured pressure difference can be integrated over the duration of the measurement and an average value can be determined over at least one cycle. It has been shown that the inline viscosity measurement method according to the invention can be used to determine highly accurate and reproducible viscosity measurement values. The viscosity measurement value can comprise, for example, an intrinsic viscosity.

In particular, the invention comprises an injection molding process including an inline viscosity measurement method. A plastic melt is melted in a plasticizing unit in the injection molding process and injected discontinuously into a molding tool. According to an embodiment, the plasticizing unit is also the injection unit. According to this embodiment, the inline viscosity measurement method is carried out in the outlet region of the plasticizing unit or the injection unit.

According to an embodiment, the plasticizing unit and the injection unit can be decoupled. According to this embodiment, the plasticizing unit feeds plastic melt into the injection unit, which is thereby filled. As soon as the injection unit contains sufficient plastic melt, the plastic melt is injected into the molding tool. During the injection process, the plasticizing unit conveys no or at least less molten plastic into the injection unit. According to this embodiment, the inline viscosity measurement method can take place in the outlet region of the injection unit or in the transition region between the plasticizing unit and the injection unit. It has been shown that it is particularly advantageous to carry out the measurement in the transition region between the plasticizing unit and the injection unit. The viscosity measurement value can be measured during the filling process of the injection unit. Since this filling process typically takes significantly longer than the injection process, the measurement results are significantly more stable and accurate. In addition, the pressures at the transition region between the plasticizing unit and the injection unit are typically significantly lower than in the outlet region of the injection unit, which significantly reduces the measurement effort required to determine the pressure difference.

In cyclic polymer processing methods, the plastic melt can flow continuously or discontinuously and varies over the duration of a cycle. In cyclic polymer processing methods, the pressure difference measured during the time period must be correlated with the flow rate relevant at the time of measurement. The measurement can be limited to partial times during which the flow rate and the associated pressure difference are within a range that is representative for the measurement. For an injection molding process, the duration can be the time it takes to inject the molten plastic into the molding tool or to fill an intermediate storage container. For an extrusion blow molding process, the duration can correspond to the time it takes to extrude the tube.

The use of a static mixer throughout the plastic melt also allows the added additives to be optimally mixed with the plastic melt. The built-in element thus ensures a homogeneous plastic melt. A homogeneous plastic melt can have a constant viscosity measurement value. If the viscosity measurement value is constant, this creates a basis for a particularly reliable measurement result.

### BRIEF DESCRIPTION OF THE DRAWINGS

Below are some examples of inline viscosity measuring devices for the cyclic polymer processing method. It is shown in

FIG. 1a a view of an inline viscosity measuring device according to a first embodiment,

FIG. 1b a sectional view of the closed channel of FIG. 1a,

FIG. 2a view of an inline viscosity measuring device according to a second embodiment,

FIG. 2b a sectional view of the closed channel of FIG. 2a,

FIG. 3a view of an inline viscosity measuring device according to a third embodiment,

FIG. 3b a sectional view of the closed channel of FIG. 3a,

FIG. 4a view of an inline viscosity measuring device according to a fourth embodiment,

FIG. 4b a sectional view of the closed channel of FIG. 4a,

FIG. 5a view of an inline viscosity measuring device according to a fifth embodiment,

FIG. 5b a sectional view of the closed channel of FIG. 5a,

FIG. 6a view of an inline viscosity measuring device according to a sixth embodiment,

FIG. 6b a sectional view of the closed channel of FIG. 6a,

FIG. 7a view of an inline viscosity measuring device according to a seventh embodiment,

FIG. 7b a sectional view of the closed channel of FIG. 7a,

FIG. 8a view of an inline viscosity measuring device according to a eighth embodiment,

FIG. 8b a sectional view of the closed channel of FIG. 8a,

FIG. 9a view of an inline viscosity measuring device according to a ninth embodiment,

FIG. 9b a sectional view of the closed channel of FIG. 9a,

FIG. 10 an example of a known viscosity measurement method,

FIG. 11 a cyclic polymer processing method with an inline viscosity measurement method,

FIG. 12 an example of the pressure difference over time for a cyclic polymer processing method,

FIG. 13 an example of the pressure difference over time for a discontinuous polymer processing method,

FIG. 14a, FIG. 14b, and FIG. 14c are examples of the pressure difference over time for variants of discontinuous polymer processing methods.

### DETAILED DESCRIPTION

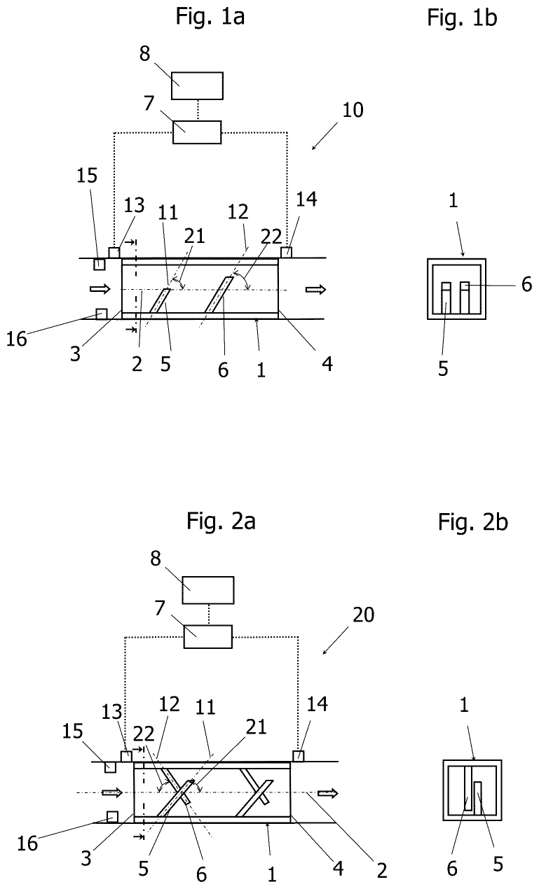

FIG. 1a shows an inline viscosity measuring device 10 for performing an inline viscosity measurement method according to one of the embodiments of the invention. The inline viscosity measuring device 10 for determining a viscosity measurement value of a fluid polymer stream contains a measuring section arranged in a closed channel 1. The fluid polymer stream flows through the measuring section. The measuring section is thus configured as a flow channel. The closed channel 1 comprises a longitudinal axis 2, an inlet end 3, and an outlet end 4. The measuring section extends between the inlet end 3 and the outlet end 4, with at least one built-in element 5, 6 arranged in the measuring section. A static mixer is formed by the measuring section. An inlet pressure sensor 13 for measuring an inlet pressure measurement value is arranged upstream of the built-in element 5, 6, for example at the inlet end 3. Downstream of the built-in element 5, 6, for example at the outlet end 4, an outlet pressure sensor 14 is arranged for measuring an outlet pressure measurement value. Alternatively, an ambient pressure can be determined at the outlet end. The device 10 contains a transducer 7 for converting the inlet pressure measurement value and the outlet pressure measurement value into measurement variables that can be processed by a computer unit 8, so that a pressure difference between the inlet pressure measurement value and the outlet pressure measurement value can be determined from the measurement variables by means of the computer unit 8.

A temperature sensor is used to determine the temperature of the fluid polymer stream in the closed channel 1. In addition, the flow rate of the fluid polymer stream through the closed channel 1 is determined. According to the present embodiment, the inline viscosity measuring device 10 contains, for example, a flow sensor 15 and a temperature sensor 16, whereby the flow sensor 15 can be used to determine the flow rate of the fluid polymer stream flowing through the closed channel 1. The temperature sensor 16 can be used to determine the temperature of the fluid polymer stream flowing through the closed channel 1, whereby the computer unit 8 can be used to determine the viscosity by means of a calculation formula based on the pressure difference, the temperature of the fluid polymer stream, and the flow rate of the fluid polymer stream. The fluid polymer stream is not a side stream with recirculation, so that the fluid polymer stream is mixed by means of the static mixer. A gap can be formed between the built-in element and an inner wall of the closed channel.

According to the present embodiment, a first built-in element 5 and a second built-in element 6 are provided. In particular, each of the first and second built-in elements 5, 6 is configured as at least one group of web elements. The web elements of the first built-in element 5 extend in a first group plane 11. The web elements of the second built-in element 6 extend in a second group plane 12. The first group plane 11 encloses a first angle 21 with the longitudinal axis of the closed channel. The second group plane 12 encloses a second angle 22 with the longitudinal axis 2 of the closed channel 1. The first angle 21 can coincide with the second angle 22. According to an embodiment not shown, the first angle 21 can differ from the second angle 22.

The web elements of the first built-in element 5 and the web elements of the second built-in element 6 extend from the inner wall of the closed channel 1 into the interior of the closed channel 1. According to the present embodiment, the web elements of the first built-in element 5 have a length that differs from that of the web elements of the second built-in element 6. According to the present embodiment, the web elements of the second built-in element 6 are at least partially longer than the web elements of the first built-in element 5. In the illustration, the two web elements of the second built-in element 6 are longer than the two web elements of the first built-in element 5. According to an embodiment not shown, the web elements of the second built-in element 6 are at least partially shorter than the web elements of the first built-in element 5.

Of course, at least one of the first or second built-in elements 5, 6 can contain more than two web elements, for example three, four, five, six, seven, or eight web elements.

Of course, only a single built-in element may be provided, either a first built-in element 5 or a second built-in element 6 or an built-in element extending from the inner wall to the opposite inner wall, which is not shown in FIG. 1a.

FIG. 1b shows a sectional view of the closed channel 1 according to FIG. 1a, which has been laid in the region of the inlet end 3, whereby the sectional plane in FIG. 1a is represented by a dotted line and arrows. The first built-in element 5 is visible in the sectional view. The first built-in element 5 is configured as two web elements. The web elements of the first built-in element 5 have center axes that lie in the first group plane 11. The second built-in element 6 is arranged behind it and is therefore partially concealed by the first built-in element 5 in this sectional view. The web elements of the second built-in element 6 have center axes that lie in the second group plane 12.

According to the first embodiment shown in FIG. 1a and FIG. 1b, the first group plane 11 runs essentially parallel to the second group plane 12. In other words, the first angles 21 and the second angles 22 are equal if the closed channel 1 is configured without curvature. In other words, the longitudinal axis 2 of the closed channel 1 forms a straight line.

FIG. 2a shows an inline viscosity measuring device 20 according to a second embodiment of the invention. The same reference symbols as in the first embodiment are used for components with the same function. The inline viscosity measuring device 20 for determining a viscosity measurement value of a fluid polymer stream contains a measuring section arranged in a closed channel 1, which is configured for the fluid polymer stream to flow through. The measuring section is configured as a flow channel. The closed channel 1 comprises a longitudinal axis 2, an inlet end 3, and an outlet end 4. The measuring section extends between the inlet end 3 and the outlet end 4, with at least one built-in element 5, 6 arranged in the measuring section. A static mixer is formed by the measuring section. According to the present embodiment, two arrangements of first and second built-in elements 5, 6 are arranged one behind the other.

An inlet pressure sensor 13 for measuring an inlet pressure measurement value is arranged at the inlet end 3. An outlet pressure sensor 14 for measuring an outlet pressure measurement value is arranged at the outlet end 4. Alternatively, an ambient pressure can be determined at the outlet end. The inline viscosity measuring device 20 contains a transducer 7 for converting the inlet pressure measurement value and the outlet pressure measurement value into measurement variables that can be processed by a computer unit 8, so that a pressure difference between the inlet pressure measurement value and the outlet pressure measurement value can be determined from the measurement variables by means of the computer unit 8. According to the present embodiment, the device 20 includes an optional flow sensor 15 and an optional temperature sensor 16, whereby the flow sensor 15 can be used to determine the flow rate of the fluid polymer stream flowing through the closed channel 1. The temperature sensor 16 can be used to determine the temperature of the fluid polymer stream flowing through the closed channel 1, whereby the computer unit 8 can be used to determine a viscosity measurement value from the pressure difference, the temperature of the fluid polymer stream, and the flow rate of the fluid polymer stream using a calculation formula. The fluid polymer stream is not a side stream with recirculation, so that the fluid polymer stream is mixed by means of the static mixer. According to this embodiment, each of the first and second built-in elements 5, 6 is designed as at least one group of web elements. The web elements that form the first built-in element 5 extend in a first group plane 11. The web elements that form the second built-in element 6 extend in a second group plane 12. The first group plane 11 encloses a first angle 21 with the longitudinal axis of the closed channel 1. The second group plane 12 encloses a second angle 22 with the longitudinal axis 2 of the closed channel 1. According to the present embodiment, the first group plane 11 intersects with the second group plane 12.

According to this embodiment, the first built-in element 5 consists of a single web element. The web element of the first built-in element 5 has a center axis that lies in the first group plane 11. The second built-in element 6 is arranged behind it and is therefore partially concealed by the first built-in element 5 in this sectional view. The web element of the second built-in element 6 has a center axis that lies in the second group plane 12. The first group plane 11 intersects with the second group plane 12. In other words, the first and second built-in elements 5, 6 intersect. The first and second built-in elements 5, 6 have web elements that are connected to the inner wall of the closed channel 1 at only one end. The opposite end of the web elements is arranged at a distance from the opposite inner wall of the closed channel 1 that is greater than the wall distance at which a wall effect occurs. The opposite end is hereinafter referred to as the free end. In particular, the distance of the free end of at least one of the web elements can be at least one tenth of the inner diameter of the closed channel. The distance can be configured as a gap. In particular, the gap has a width that is at least 10% of the diameter DS of the closed channel. The web element of the first built-in element 5 can differ in length from the web element of the second built-in element 6.

FIG. 2a shows a first arrangement and a second arrangement. The first arrangement consists of the first and second built-in elements 5, 6. According to this embodiment, the second arrangement also consists of similar first and second built-in elements 5, 6, which are not labeled in FIG. 2a and are not visible in FIG. 2b because they are covered by the first and second built-in elements 5, 6 of the upstream first arrangement.

FIG. 2b shows a sectional view of the closed channel 1 according to FIG. 2a, which has been laid in the region of the inlet end 3, with the sectional plane being represented by a dotted line and arrows. The sectional view shows the first built-in element 5 and the second built-in element 6 of the first arrangement.

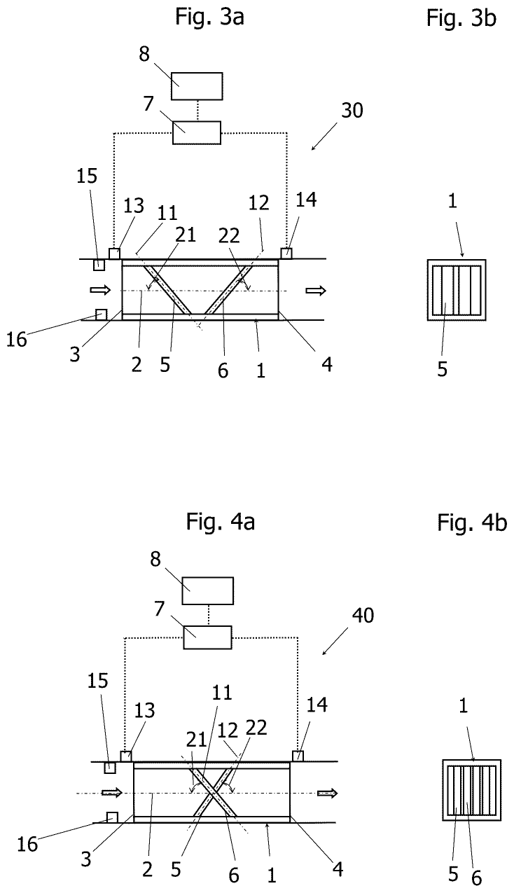

FIG. 3a shows an inline viscosity measuring device 30 according to a third embodiment of the invention. The inline viscosity measuring device 30 for determining a viscosity measurement value of a fluid polymer stream contains a measuring section arranged in a closed channel 1, which is configured for the fluid polymer stream to flow through. The measuring section is configured as a flow channel. The closed channel 1 comprises a longitudinal axis 2, an inlet end 3, and an outlet end 4. The measuring section extends between the inlet end 3 and the outlet end 4, with at least one built-in element 5, 6 arranged in the measuring section. A static mixer is formed by the measuring section. An inlet pressure sensor 13 for measuring an inlet pressure measurement value is arranged at the inlet end 3. An outlet pressure sensor 14 for measuring an outlet pressure measurement value is arranged at the outlet end 4. Alternatively, an ambient pressure can be determined at the outlet end. The inline viscosity measuring device 30 contains a transducer 7 for converting the inlet pressure measurement value and the outlet pressure measurement value into measurement variables that can be processed by a computer unit 8, so that the computer unit 8 can use the measurement variables to determine a pressure difference between the inlet pressure measurement value and the outlet pressure measurement value. According to the present embodiment, the device 30 additionally contains an optional flow sensor 15 and an optional temperature sensor 16, whereby the flow sensor 15 can be used to determine the flow rate of the fluid polymer stream flowing through the closed channel 1. The temperature sensor 16 can be used to determine the temperature of the fluid polymer stream flowing through the closed channel 1, whereby the computer unit 8 can be used to determine a viscosity measurement value from the pressure difference, the temperature of the fluid polymer stream, and the flow rate of the fluid polymer stream. The fluid polymer stream is not a side stream with recirculation, so that the fluid polymer stream is mixed by means of the static mixer. A gap can be formed between at least one of the first and second built-in elements 5, 6 and an inner wall of the closed channel.

According to the present embodiment, a first built-in element 5 and a second built-in element 6 are provided. Each of the first and second built-in elements 5, 6 can be formed as at least one group of web elements extending in a first group plane 11 and a second group plane 12. The first group plane 11 encloses a first angle 21 with the longitudinal axis of the closed channel, and the second group plane 12 encloses a second angle 22 with the longitudinal axis 2 of the closed channel 1.

FIG. 3b shows a sectional view of the closed channel 1 according to FIG. 3a, which has been laid in the area of the inlet end 3. The first built-in element 5 is visible in the sectional view. The second built-in element 6 is located behind it and is therefore concealed by the first built-in element 5 in this sectional view. According to the present embodiment, the first built-in element 5 consists of two web elements.

FIG. 4a shows an inline viscosity measuring device 40 according to a fourth embodiment of the invention. The same reference symbols as in the first embodiment are used for components with the same function. The inline viscosity measuring device 40 for determining a viscosity measurement value of a fluid polymer stream contains a measuring section arranged in a closed channel 1, which is configured for the fluid polymer stream to flow through. The measuring section is configured as a flow channel. The closed channel 1 comprises a longitudinal axis 2, an inlet end 3, and an outlet end 4. The measuring section extends between the inlet end 3 and the outlet end 4, with at least one built-in element 5, 6 arranged in the measuring section. An inlet pressure sensor 13 for measuring an inlet pressure measurement value is arranged at the inlet end 3. An outlet pressure sensor 14 for measuring an outlet pressure measurement value is arranged at the outlet end 4. Alternatively, an ambient pressure can be determined at the outlet end. The device 40 contains a transducer 7 for converting the inlet pressure measurement value and the outlet pressure measurement value into measurement variables that can be processed by a computer unit 8, so that a pressure difference between the inlet pressure measurement value and the outlet pressure measurement value can be determined from the measurement variables by means of the computer unit 8. According to the present embodiment, the device 40 additionally comprises an optional flow sensor 15 and an optional temperature sensor 16, wherein the flow sensor 15 can be used to determine the flow rate of the fluid polymer stream flowing through the closed channel 1. The temperature sensor 16 can be used to determine the temperature of the fluid polymer stream flowing through the closed channel 1, whereby the computer unit 8 can use a calculation formula to determine a viscosity measurement value from the pressure difference, the temperature of the fluid polymer stream, and the flow rate. The fluid polymer stream is not a side stream with recirculation, so that the fluid polymer stream is mixed by means of the static mixer. A gap can be formed between the built-in element and an inner wall of the closed channel.

According to this embodiment, the first and second built-in elements 5, 6 are configured as at least one group of web elements each, which extend in a first group plane 11 and a second group plane 12, wherein the first group plane 11 encloses a first angle 21 with the longitudinal axis of the closed channel and the second group plane 12 encloses a second angle 22 with the longitudinal axis 2 of the closed channel 1. According to the present embodiment, the first group plane 11 intersects the second group plane 12.

FIG. 4b shows a sectional view of the closed channel 1 according to FIG. 4a, which has been laid in the region of the inlet end 3. The first built-in element 5 and the second built-in element 6 are visible in the sectional view. According to this exemplary embodiment, the first built-in element 5 consists of two web elements and the second built-in element 6 consists of two web elements.

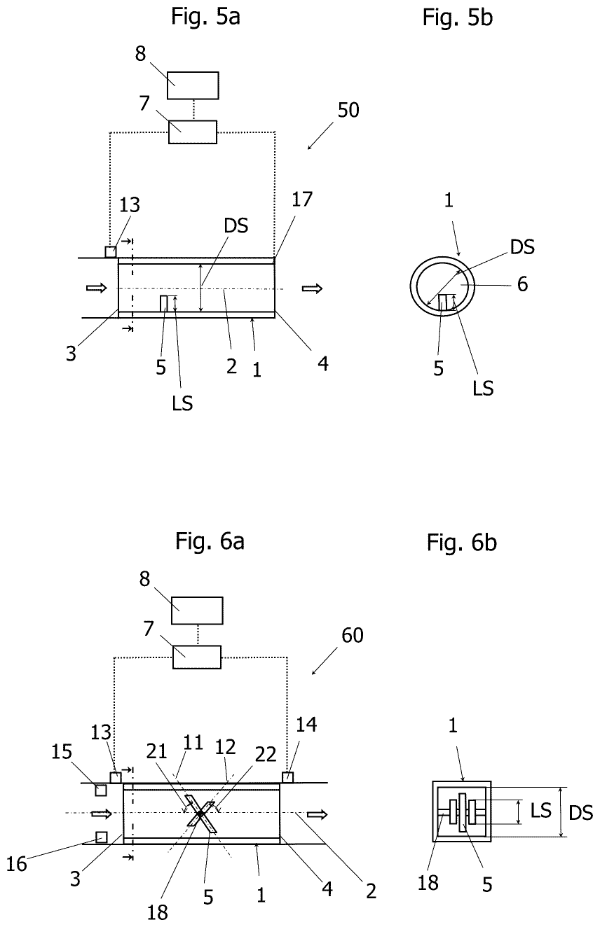

FIG. 5a shows an inline viscosity measuring device 50 according to a fifth embodiment of the invention. The inline viscosity measuring device 50 for determining a viscosity measurement value of a fluid polymer stream contains a measuring section arranged in a closed channel 1, which is configured for the fluid polymer stream to flow through. The measuring section is configured as a flow channel. The closed channel 1 comprises a longitudinal axis 2, an inlet end 3, and an outlet end 4. The measuring section extends between the inlet end 3 and the outlet end 4, with at least one built-in element 5 arranged in the measuring section. A static mixer is formed by the measuring section. An inlet pressure sensor 13 for measuring an inlet pressure measurement value is arranged at the inlet end 3. An outlet pressure measurement value 17 is determined at the outlet end 4. According to the present embodiment, an ambient pressure is determined at the outlet end. The inline viscosity measuring device 50 contains a transducer 7 for converting the inlet pressure measurement value and the outlet pressure measurement value into measurement variables that can be processed by a computer unit 8, so that a pressure difference between the inlet pressure measurement value and the outlet pressure measurement value can be determined from the measurement variables by means of the computer unit 8. The inline viscosity measuring device 50 can additionally contain an optional flow sensor and/or an optional temperature sensor. Alternatively, another measuring sensor for the flow rate can be provided instead of a flow sensor. For example, the rotational speed of a screw element of an extruder or a melt pump can be determined. The flow rate of the fluid polymer stream flowing through the closed channel 1 can be determined using the flow sensor or another measuring sensor. Using the optional temperature sensor, the temperature of the fluid polymer stream flowing through the closed channel 1 can be determined, whereby a viscosity measurement value can be determined using a calculation rule from the pressure difference, the temperature of the fluid polymer stream (if applicable), and the flow rate of the fluid polymer stream (if applicable) using the computer unit 8. The fluid polymer stream is not a side stream with recirculation, so that the fluid polymer stream is mixed by means of the static mixer. A gap can be formed between the built-in element and an inner wall of the closed channel.

According to the present embodiment, the built-in element comprises a first built-in element 5. In particular, the first built-in element 5 is configured as at least one web element. The web element protrudes into the flow channel with a web element length LS that is at least 25% of the diameter DS of the flow channel.

The web element or web elements of the first built-in element 5 extend from the inner wall of the closed channel 1 into the interior of the closed channel 1 or the flow channel.

Of course, the built-in element 5 can contain two web elements or more than two web elements, for example three, four, five, six, seven, or eight web elements.

Of course, the built-in element can extend from the inner wall to the opposite inner wall of the closed channel, which is not shown in FIG. 5a or FIG. 5b.

FIG. 5b shows a sectional view of the closed channel 1 according to FIG. 5a, which has been laid in the region of the inlet end 3, with the sectional plane being represented by a dotted line and arrows. The first built-in element 5 is visible in the sectional view. According to this exemplary embodiment, the first built-in element 5 consists of a single web element.

At least one web element of the first built-in element 5 can enclose an angle of 90 degrees with respect to the longitudinal axis 2, as shown in FIG. 5a. The angle can also deviate from 90 degrees, which is not shown in the drawing.

FIG. 6a shows an inline viscosity measuring device 60 according to a sixth embodiment of the invention. The inline viscosity measuring device 60 for determining a viscosity measurement value of a fluid polymer stream contains a measuring section arranged in a closed channel 1, which is configured for the fluid polymer stream to flow through. The measuring section is configured as a flow channel. The closed channel 1 comprises a longitudinal axis 2, an inlet end 3, and an outlet end 4. The measuring section extends between the inlet end 3 and the outlet end 4, with at least one built-in element 5 arranged in the measuring section. A static mixer is formed by the measuring section. An inlet pressure sensor 13 for measuring an inlet pressure measurement value is arranged at the inlet end 3. An outlet pressure sensor 14 for measuring an outlet pressure measurement value is arranged at the outlet end 4. Alternatively, an ambient pressure can be determined at the outlet end, as shown in FIG. 5a. The inline viscosity measuring device 60 contains a transducer 7 for converting the inlet pressure measurement value and the outlet pressure measurement value into measurement variables that can be processed by a computer unit 8, so that a pressure difference between the inlet pressure measurement value and the outlet pressure measurement value can be determined from the measurement variables by means of the computer unit 8. The inline viscosity measuring device 60 can additionally contain an optional flow sensor 15 and/or an optional temperature sensor 16. Alternatively, instead of a flow sensor, another measuring sensor for the flow rate can be provided. For example, the rotational speed of a screw element of an extruder or a melt pump may be determined. The flow sensor or another measuring sensor can be used to determine the flow rate of the fluid polymer stream flowing through the closed channel 1. The optional temperature sensor can be used to determine the temperature of the fluid polymer stream flowing through the closed channel 1, whereby a viscosity measurement value can be determined by the computer unit 8 from the pressure difference, the temperature of the fluid polymer stream, if applicable, and the flow rate of the fluid polymer stream, if applicable. The fluid polymer stream is not a side stream with recirculation, so that the fluid polymer stream is mixed by means of the static mixer. A gap can be formed between the built-in element and an inner wall of the closed channel.

According to the present embodiment, only a first built-in element 5 is provided. In particular, the first built-in element 5 contains at least one web element. The web element protrudes into the flow channel with a web element length LS that is at least 25% of a diameter DS of the flow channel, see also FIG. 6b.

The web element or web elements of the first built-in element 5 extend from the center axis of the closed channel 1 into the interior of the closed channel 1 or the flow channel. According to the present embodiment, the web element or each of the web elements has a first web element end and a second web element end, whereby neither the first web element end nor the second web element end is connected to the closed channel 1. In particular, both the first web element end and the second web element end are spaced apart from an inner wall of the closed channel 1 by a distance corresponding to at least 10% of the inner diameter of the closed channel or the diameter DS of the flow channel. According to an embodiment, the web element contains a web element arm 18, which is configured as a connecting element to the inner wall of the closed channel. In FIG. 6a, one of the two web element arms 18 is shown in section, since the front side wall of the closed channel 1 lies in front of the section plane and is therefore cut away in FIG. 6a.

According to an embodiment, at least 60% of the cross-sectional area of the closed channel 1 is covered by the web element(s). In particular, at least 60% of the cross-sectional area and at most 90% of the cross-sectional area of the closed channel is covered by the web element(s). In particular, at least two web elements can be provided. If two or more web elements are provided, they can be connected to each other via web element arms 18, as shown in FIG. 6b.

According to the present embodiment, the first built-in element 5 is configured as a group of web elements extending in a first group plane 11 and a second group plane 12, wherein the first group plane 11 encloses a first angle 21 with the longitudinal axis of the closed channel and the second group plane 12 encloses a second angle 22 with the longitudinal axis 2 of the closed channel 1. According to the present embodiment, the first group plane 11 intersects with the second group plane 12. Of course, the first built-in element 5 can contain two web elements or more than two web elements, for example three, four, five, six, seven, eight web elements. Of course, the built-in element can extend from the inner wall to the opposite inner wall of the closed channel, which is not shown in FIG. 6a or FIG. 6b.

FIG. 6b shows a sectional view of the closed channel 1 according to FIG. 6a, which has been laid in the region of the inlet end 3, with the sectional plane being represented by a dotted line and arrows. The first built-in element 5 is visible in the sectional view. According to this exemplary embodiment, the first built-in element 5 consists of three web elements.

The web elements of the built-in element 5 can form an angle of less than or more than 90 degrees with respect to the longitudinal axis 2, as shown in FIG. 6a. The angle can also be 90 degrees, which is not shown in the drawing.

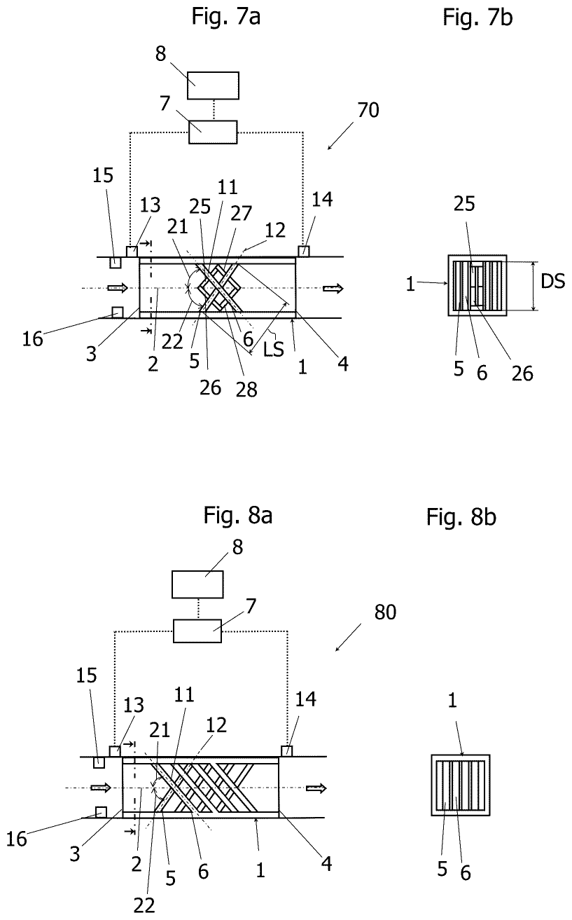

FIG. 7a shows an inline viscosity measuring device 70 according to a seventh embodiment of the invention. The inline viscosity measuring device 70 for determining a viscosity measurement value of a fluid polymer stream contains a measuring section arranged in a closed channel 1, which is configured for the fluid polymer stream to flow through. The measuring section is configured as a flow channel. The closed channel 1 comprises a longitudinal axis 2, an inlet end 3, and an outlet end 4. The measuring section extends between the inlet end 3 and the outlet end 4, with at least one built-in element 5 arranged in the measuring section. A static mixer is formed by the measuring section. An inlet pressure sensor 13 is arranged at the inlet end 3 to measure an inlet pressure measurement value. An outlet pressure sensor 14 is arranged at the outlet end 4 to measure an outlet pressure measurement value. Alternatively, an ambient pressure can be determined at the outlet end, as shown in FIG. 5a. The inline viscosity measuring device 70 contains a transducer 7 for converting the inlet pressure measurement value and the outlet pressure measurement value into measurement variables that can be processed by a computer unit 8, so that a pressure difference between the inlet pressure measurement value and the outlet pressure measurement value can be determined from the measurement variables by means of the computer unit 8. The inline viscosity measuring device 70 can additionally contain an optional flow sensor 15 and/or an optional temperature sensor 16. Alternatively, instead of a flow sensor, another measuring sensor can be provided for measuring the flow rate. For example, the rotational speed of a screw element of an extruder or a melt pump can be determined. Using the flow sensor or another measuring sensor, the flow rate of the fluid polymer stream flowing through the closed channel 1 can be determined. The optional temperature sensor can be used to determine the temperature of the fluid polymer stream flowing through the closed channel 1, whereby the viscosity measurement value can be determined by the computer unit 8 from the pressure difference, the temperature of the fluid polymer stream, if applicable, and the flow rate of the fluid polymer stream, if applicable. The fluid polymer stream is not a side stream with recirculation, so that the fluid polymer stream is mixed by means of the static mixer. A gap can be formed between the built-in element and an inner wall of the closed channel. The built-in element can be configured as at least one first built-in element 5 and at least one second built-in element 6.

According to the present embodiment, a first built-in element 5 and a second built-in element 6 are provided, which extend from an inner wall of the channel to an opposite inner wall of the closed channel 1. In particular, the first built-in element 5 and the second built-in element 6 each contain at least one web element. The web element has a web element length LS that is greater than the inner diameter DS of the flow channel, as shown in FIG. 7a and FIG. 7b.

In addition to the web elements of the first built-in element 5 and the second built-in element, a plurality of web elements 25, 26, 27, 28 extend from the center axis of the closed channel 1 into the interior of the closed channel 1 or the flow channel. According to the present embodiment, the web element or each of the web elements has a first web element end and a second web element end, each of the first web element ends and second web element ends being connected to a first web element end or a second web element end of an adjacent web element. According to the present embodiment, four such web elements 25, 26, 27, 28 are provided, which form a quadrangle. These web elements can be connected via web element arms (not shown) to the web elements of the first built-in element 5 or to the web elements of the second built-in element 6. Alternatively, two edges arranged diagonally in the quadrangle, which are formed by the web element ends of two adjacent web elements, can be connected to the inner wall of the closed channel 1.

According to an embodiment, at least 60% of the cross-sectional area of the closed channel is covered by the web element(s). In particular, at least 60% of the cross-sectional area and at most 90% of the cross-sectional area of the closed channel is covered by the web element(s). In particular, at least two web elements can be provided. If two or more web elements are provided, they can be connected to each other by web element arms.

According to the present embodiment, the first built-in element 5 is thus configured as a group of web elements extending in a first group plane 11, wherein the first group plane 11 encloses a first angle 21 with the longitudinal axis of the closed channel 1. According to the present embodiment, the second built-in element 6 is configured as a group of web elements extending in a second group plane 12, wherein the second group plane 12 encloses a second angle 22 with the longitudinal axis of the closed channel 1. According to the present embodiment, the first group plane 11 intersects with the second group plane 12. Of course, the built-in element 5 can contain two web elements or more than two web elements, for example three, four, five, six, seven, or eight web elements. Of course, the first built-in element 5 and the second built-in element 6 cannot extend from the inner wall to the opposite inner wall of the closed channel 1, but, as shown in FIG. 6b, can be connected to the inner wall of the closed channel via web element arms.

FIG. 7b shows a sectional view of the closed channel 1 according to FIG. 7a, which has been laid in the region of the inlet end 3, with the sectional plane being represented by a dotted line and arrows. The sectional view shows the first built-in element 5, the second built-in element 6, and the web elements 25, 26 arranged in a rectangle. The web elements 27, 28 behind them are not visible in FIG. 7b.

The web elements of the first built-in element 5 and the second built-in element 6 can enclose an angle of less than or more than 90 degrees with respect to the longitudinal axis 2, as shown in FIG. 7a. The angle can also be 90 degrees, which is not shown in the drawing.

FIG. 8a shows an inline viscosity measuring device 80 according to an eighth embodiment of the invention. The inline viscosity measuring device 80 for determining a viscosity measurement value of a fluid polymer stream contains a measuring section arranged in a closed channel 1, which is configured for the fluid polymer stream to flow through. The measuring section is configured as a flow channel. The closed channel 1 comprises a longitudinal axis 2, an inlet end 3, and an outlet end 4. The measuring section extends between the inlet end 3 and the outlet end 4, with at least one built-in element 5 arranged in the measuring section. A static mixer is formed by the measuring section. An inlet pressure sensor 13 is arranged at the inlet end 3 to measure an inlet pressure measurement value. An outlet pressure sensor 14 is arranged at the outlet end 4 to measure an outlet pressure measurement value. Alternatively, an ambient pressure can be determined at the outlet end, as shown in FIG. 5a. The inline viscosity measuring device 80 contains a transducer 7 for converting the inlet pressure measurement value and the outlet pressure measurement value into measurement variables that can be processed by a computer unit 8, so that a pressure difference between the inlet pressure measurement value and the outlet pressure measurement value can be determined from the measurement variables by means of the computer unit 8. The inline viscosity measuring device 80 can additionally contain an optional flow sensor 15 and/or an optional temperature sensor 16. Alternatively, instead of a flow sensor, another measuring sensor can be provided for flow rate. For example, the rotational speed of a screw element of an extruder or a melt pump can be determined. Using the flow sensor or another measuring sensor, the flow rate of the fluid polymer stream flowing through the closed channel 1 can be determined. The optional temperature sensor 16 can be used to determine the temperature of the fluid polymer stream flowing through the closed channel 1, whereby the viscosity measurement value can be determined by the computer unit 8 from the pressure difference, the temperature of the fluid polymer stream, if applicable, and the flow rate of the fluid polymer stream, if applicable. The fluid polymer stream is not a side stream with recirculation, so that the fluid polymer stream is mixed by means of the static mixer. A gap can be formed between the built-in element and an inner wall of the closed channel.

The built-in element can be configured as at least one first built-in element 5 and at least one second built-in element 6.

At least one of the first and second built-in elements 5, 6 is configured as at least one group of web elements extending in a first group plane 11 and a second group plane 12, wherein the first group plane 11 encloses a first angle 21 with the longitudinal axis of the closed channel and the second group plane 12 encloses a second angle 22 with the longitudinal axis 2 of the closed channel 1. According to the present embodiment, the first group plane 11 intersects the second group plane 12. According to the present embodiment, several first group planes 11 are arranged one behind the other in the direction of flow. According to the present embodiment, several second group planes 12 are arranged one behind the other in the direction of flow. For simplicity, reference symbols have been used in FIG. 8a only for the first group of web elements of the first built-in element 5 and the first group of web elements of the second built-in element 6, which is closest to the inlet end 3.

FIG. 8b shows a sectional view of the closed channel 1 according to FIG. 8a, which has been laid in the region of the inlet end 3. The first built-in element 5 and the second built-in element 6 are visible in the sectional view. According to this exemplary embodiment, each group of web elements of the first built-in element 5 contains two web elements and each group of web elements of the second built-in element 6 contains two web elements.

According to an embodiment, at least 60% of the cross-sectional area of the closed channel 1 is covered by the web element(s). In particular, at least 60% of the cross-sectional area and at most 90% of the cross-sectional area of the closed channel is covered by the web element(s). In particular, at least four web elements can be provided for the first built-in element 5. In particular, at least four web elements can be provided for the second built-in element 6. The web elements of the first built-in element 5 are arranged crosswise to the web elements of the second built-in element 6. Adjacent web elements of the first and second built-in elements can be connected to each other via web element arms. The web element arms can run in particular in the intersection area of the web elements.

According to an embodiment, at least 60% of the cross-sectional area of the closed channel 1 is covered by the web element(s). In particular, at least 60% of the cross-sectional area and at most 90% of the cross-sectional area of the closed channel is covered by the web element(s). In particular, at least four web elements can be provided for the first built-in element 5. In particular, at least four web elements can be provided for the second built-in element 6. The web elements of the first built-in element 5 are arranged crosswise to the web elements of the second built-in element 6. Adjacent web elements of the first and second built-in elements can be connected to each other via web element arms. The web element arms can run in particular in the intersection region of the web elements.

According to the present embodiment, the first built-in element 5 is thus configured as a plurality of groups of web elements extending in a first group plane 11, wherein the first group plane 11 encloses a first angle 21 with the longitudinal axis of the closed channel 1. According to the present embodiment, the second built-in element 6 is configured as a plurality of groups of web elements extending in a second group plane 12, wherein the second group plane 12 encloses a second angle 22 with the longitudinal axis of the closed channel 1. According to the present embodiment, the first group plane 11 intersects with the second group plane 12. Each of the groups of web elements of the first built-in element 5 can contain two web elements or more than two web elements, for example three, four, five, six, seven, eight web elements. Each of the groups of web elements of the second built-in element 6 can contain two web elements or more than two web elements, for example three, four, five, six, seven, eight web elements. Of course, the first built-in element 5 and the second built-in element 6 may also not extend from the inner wall to the opposite inner wall of the closed channel 1, but, as shown in FIG. 6b, can be connected to the inner wall of the closed channel via web element arms.

FIG. 8b shows a sectional view of the closed channel 1 according to FIG. 8a, which has been laid in the region of the inlet end 3, with the sectional plane being represented by a dotted line and arrows. In the sectional view, the first group of web elements of the first built-in element 5 and of the second built-in element 6 are visible in each case.

The web elements of the first built-in element 5 and the second built-in element 6 can enclose an angle 21, 22 of less than or more than 90 degrees with respect to the longitudinal axis 2, as shown in FIG. 8a. The angle can also be 90 degrees, which is not shown in the drawing.

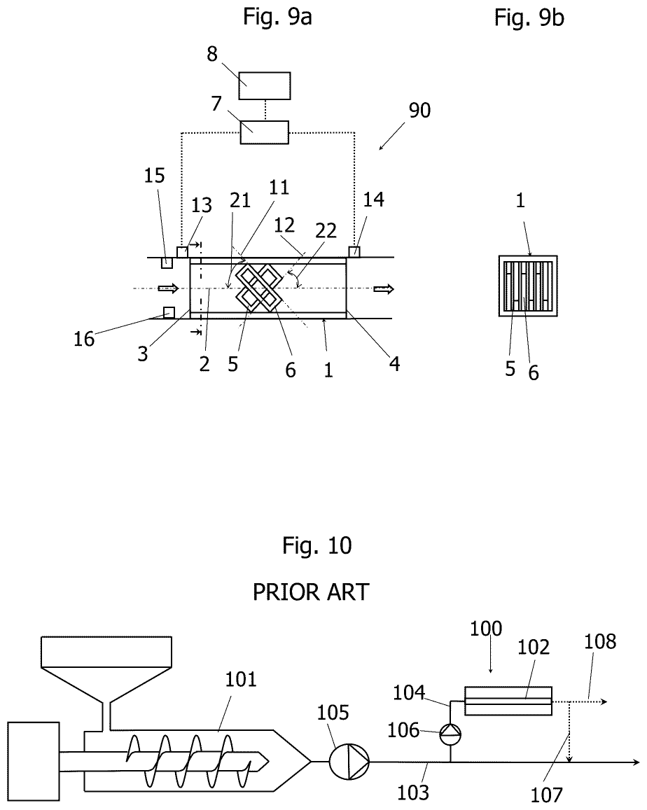

FIG. 9a shows an inline viscosity measuring device 90 according to a ninth embodiment of the invention. The inline viscosity measuring device 90 for determining a viscosity measurement value of a fluid polymer stream contains a measuring section arranged in a closed channel 1, which is configured for the fluid polymer stream to flow through. The measuring section is configured as a flow channel. The closed channel 1 comprises a longitudinal axis 2, an inlet end 3, and an outlet end 4. The measuring section extends between the inlet end 3 and the outlet end 4, with at least one built-in element 5 arranged in the measuring section. A static mixer is formed by the measuring section. An inlet pressure sensor 13 for measuring an inlet pressure measurement value is arranged at the inlet end 3. An outlet pressure sensor 14 for measuring an outlet pressure measurement value is arranged at the outlet end 4. Alternatively, an ambient pressure can be determined at the outlet end, as shown in FIG. 5a. The inline viscosity measuring device 90 contains a transducer 7 for converting the inlet pressure measurement value and the outlet pressure measurement value into measurement variables that can be processed by a computer unit 8, so that a pressure difference between the inlet pressure measurement value and the outlet pressure measurement value can be determined from the measurement variables by means of the computer unit 8. The inline viscosity measuring device 90 can additionally contain an optional flow sensor 15 and/or an optional temperature sensor 16. Alternatively, instead of a flow sensor, another measuring sensor can be provided for the flow rate. For example, the rotational speed of a screw element of an extruder or a melt pump can be determined. The flow rate of the fluid polymer stream flowing through the closed channel 1 can be determined using the flow rate sensor or another measuring sensor. The optional temperature sensor 16 can be used to determine the temperature of the fluid polymer stream flowing through the closed channel 1, whereby the viscosity measurement value can be determined by the computer unit 8 from the pressure difference, the temperature of the fluid polymer stream, if applicable, and the flow rate of the fluid polymer stream, if applicable. The fluid polymer stream is not a side stream with recirculation, so that the fluid polymer stream is mixed by means of the static mixer. A gap can be formed between the built-in element and an inner wall of the closed channel.

The built-in element can be configured as at least one first built-in element 5 and at least one second built-in element 6.

According to the present embodiment, a first built-in element 5 and a second built-in element 6 are provided, which extend from one inner wall of the channel to an opposite inner wall of the closed channel 1. In particular, the first built-in element 5 and the second built-in element 6 each contain at least one web element.

The first built-in element 5 and the second built-in element 6 contain a plurality of web elements that form a quadrangle and constitute a web element arrangement. According to the present embodiment, each of the web elements of the web element arrangement has a first web element end and a second web element end, wherein each of the first web element ends and second web element ends is connected to a first web element end or a second web element end of an adjacent web element. According to the present embodiment, four such web elements form a first web element arrangement, which is configured as the first built-in element 5. According to the present embodiment, the web element arrangement forms a quadrangle, in particular a rectangle. According to the present embodiment, four further web elements form a second web element arrangement, which is configured as the second built-in element 6. The web elements of the first built-in element 5 can be connected to the web elements of the second built-in element 6 or to the inner wall of the channel via web element arms (not shown). Alternatively, two edges arranged diagonally in the quadrangle, which are formed by the web element ends of two adjacent web elements, can be connected to the inner wall of the closed channel 1.

According to an embodiment, at least 60% of the cross-sectional area of the closed channel 1 is covered by the web element(s). In particular, at least 60% of the cross-sectional area and at most 90% of the cross-sectional area of the closed channel is covered by the web element(s). In particular, at least two web element arrangements can be provided. If two or more web element arrangements are provided, they can be connected to each other via web element arms.

According to the present embodiment, the first built-in element 5 is thus configured as a group of web elements that can form at least one web element arrangement extending in a first group plane 11, wherein the first group plane 11 encloses a first angle 21 with the longitudinal axis of the closed channel 1. According to the present embodiment, the second built-in element 6 is configured as a group of web elements that can form at least one web element arrangement extending in a second group plane 12, wherein the second group plane 12 encloses a second angle 22 with the longitudinal axis of the closed channel 1. According to the present embodiment, the first group plane 11 intersects with the second group plane 12. Of course, the built-in element 5 can contain two or more web element arrangements, for example three, four, five, six, seven, or eight web element arrangements. Of course, the first built-in element 5 and the second built-in element 6 may also not extend from the inner wall to the opposite inner wall of the closed channel 1, but can be connected to the inner wall of the closed channel via web element arms, as shown in FIG. 6b.

FIG. 9b shows a sectional view of the closed channel 1 according to FIG. 9a, which has been laid in the region of the inlet end 3, with the sectional plane being represented by a dotted line and arrows. In the sectional view, the first built-in element 5 and the second built-in element 6 are visible, each with the web elements of the first and second web element arrangements arranged in a rectangle.

The web elements of the first built-in element 5 and the second built-in element 6 can enclose an angle of less than or more than 90 degrees with respect to the longitudinal axis 2, as shown in FIG. 9a. The angle can also be 90 degrees, which is not shown in the drawing.

According to each of the embodiments, the web element or at least part of the web elements can extend across the entire inner diameter of the closed channel.

The inner diameter can correspond to a mean diameter if the cross-section of the closed channel is not circular. The mean diameter corresponds to the inner diameter if the closed channel has a circular cross-sectional area. The mean diameter for a rectangular or oval closed channel is defined as its circumference/n, which is therefore an equivalent diameter.

The dimensions of a web element are determined by its length, width, and thickness. The length of the web element is measured from the first end of the web element to the second end of the web element.

The width of the web element is measured essentially transverse to the direction of flow. This means that the width essentially extends in a plane that runs perpendicular to the length of the web element and shows the cross-section of the web element. The cross-section of the web element is characterized by its width and thickness. The length of at least the longest web element is at least 5 times its width.

The width of the web element is 0.5 to 5 times its thickness, preferably 0.5 to 3 times its thickness. If the width of the web element is 0.5 to 2 times its thickness, this results in a particularly preferred range in which the influence of wall effects is minimal. The width of the web element is defined as the normal distance extending from the first edge and the second edge of the web element on the upstream side. The width of the web element on the upstream side can differ from the width of the web element measured on the downstream side.

An edge is understood to be the edge of the web element that is approached and flowed around by the fluid, which essentially extends parallel to the length of the web element. The thickness of the web element can be variable. The minimum thickness is less than 75% and, advantageously, less than 50% below the maximum thickness. The variations can be caused, for example, by ribs, indentations, nubs, wedge-shaped webs, or other profile variations or unevenness.

The web element is characterized by the fact that, in the direction of flow, there are flat surfaces, convex surfaces, or concave surfaces that provide a contact surface for the polyester melt. These surfaces, which are aligned in the direction of flow, cause increased flow resistance compared to a web element configured as a tubular element with a circular cross-sectional area.

The transition from at least one of the first and second ends of the web element to the inner wall of the closed channel may be configured to be particularly smooth. The web elements and the closed channel can therefore consist of a single component, which is preferably manufactured by a casting process or an additive manufacturing process. In particular, the edges in the transition region from the web element to the closed channel can be rounded so that the flow of the castable material during the manufacturing process of the closed channel for the device is not impaired.

FIG. 10 shows a known viscosity measuring device 100 for measuring viscosity. This viscosity measuring device 100 is used in a polymer processing method. Such a polymer can, for example, be produced continuously by means of an extruder 101. The viscosity measuring device 100 is configured such that the viscosity of the polymer can be determined by means of a pressure difference across an orifice or a capillary 102. The previously known viscosity measurement method proceeds as follows: a side stream 104 is branched off from the polymer stream 103 and the viscosity of the side stream 104 is determined by means of a pressure difference across the orifice or the capillary 102 through which the side stream 104 is passed. In this embodiment, a pump 105 is arranged in the polymer stream and a side stream pump 106 is arranged in the side stream 104. The pump 105 in the main flow is optional. However, this known viscosity measurement method has various disadvantages. The viscosity in the side stream 104 is not representative of the polymer stream 103. Due to the low side stream flow rates, which are particularly low when using the viscosity measurement device for polyester, orifices or capillaries 102 with very small diameters are required. However, these orifices or capillaries 102 can be prone to clogging, especially when processing polymer recyclates.

For the reasons mentioned above, the viscosity of polymers cannot be measured reliably using conventional viscosity measuring devices. A viscosity measurement value obtained using the known viscosity measuring device cannot therefore be used as a signal for controlling a parameter that influences viscosity and thus cannot be used to control or monitor the quality of the polymer produced by the polymer processing method. In other words, due to the inherent fluctuation range of the signal obtained with the known viscosity measuring device, controlling the quality of the polymer based on this signal is too unreliable in practice and therefore not feasible.

A continuously flowing fluid polymer stream 103 is required for viscosity measurement using an orifice or capillary 102. In cyclic polymer processing methods, the polymer stream varies. For cyclic polymer processing methods, it has proven difficult in the past to divert a stable, constant side stream 104 for viscosity measurement for the reasons mentioned above. In addition, only the viscosity in a small side stream 104 is measured, so the viscosity measurement obtained is not representative of the polymer stream 103. Such a side stream 104 is typically in a range between 0.1% and 2% of the polymer stream 103. The viscosity measuring devices available on the market are also very expensive, as they require an additional side stream pump 106 to convey the side stream 104.

Advantageously, the side stream 104 can be fed back into the polymer stream 103 after passing through the viscosity measuring device 100. According to this embodiment, the side stream 104 is configured as a bypass side stream 107. However, in the case of polymers that tend to clog, it is also possible that the side stream 104 is altered after measurement in such a way that its return to the polymer stream 103 is not advisable, in which case a waste stream 108 is produced, which has the additional disadvantage that part of the polymer is unusable for further processing and must be recycled at greater expense or even disposed of.

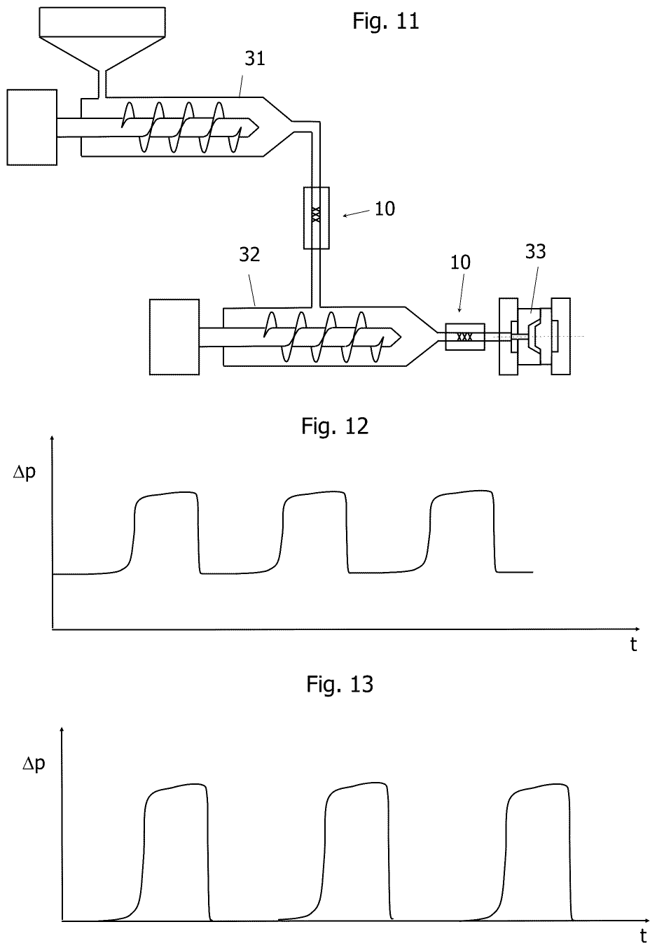

FIG. 11 shows an example of a cyclic polymer processing method containing an inline viscosity measuring device 10 according to one of the preceding embodiments of an inline viscosity measuring method. The cyclic polymer processing method is, for example, an injection molding method. The inline viscosity measuring device with reference number 10 is only an example of one of the inline viscosity devices 10, 20, 30, 40, 50, 60, 70, 80, 90 or combinations thereof. The inline viscosity device 10 is mentioned for the sake of simplicity as representative of all claimed embodiments, in particular for one of the inline viscosity devices 10, 20, 30, 40, 50, 60, 70, 80, 90 or combinations thereof.

A plastic melt is melted in a plasticizing unit using an injection molding process and injected discontinuously into a molding tool. According to an embodiment not shown, the plasticizing unit is also the injection unit. According to this embodiment, the inline viscosity measurement method is carried out in the outlet region of the plasticizing unit or the injection unit.

According to the embodiment shown in FIG. 11, the plasticizing unit 31 and the injection unit 32 can be decoupled. According to this embodiment, the plasticizing unit 31 feeds molten plastic into the injection unit 32, which is thereby filled. As soon as the injection unit 32 contains sufficient plastic melt, the plastic melt is injected into the molding tool 33. During the injection process, the plasticizing unit 31 does not feed any or at least less plastic melt into the injection unit 32. The injection unit 32 can be configured as an extruder, for example. The injection unit 32 can be configured as an intermediate storage container. The intermediate storage container can be configured as a cylinder containing a piston. The intermediate storage container can be filled with the plasticizing unit 31 (also referred to as an extruder), after which a valve is closed and the contents of the cylinder is emptied into the molding tool 33. The measurement is carried out while the cylinder is being filled, and the flow rate can be determined precisely via the displacement of the piston.

According to this embodiment, the inline viscosity measurement method can be carried out using an inline viscosity device 10 in the outlet region of the injection unit 32 or in the transition region between the plasticizing unit 31 and the injection unit 32. It has been shown that it is particularly advantageous to carry out the measurement in the transition region between the plasticizing unit 31 and the injection unit 32. In this case, the viscosity measurement value can be measured during the filling process of the injection unit 32. Since this filling process typically takes significantly longer than the injection process, the measurement results are significantly more stable and accurate. In addition, the pressures in the transition region between the plasticizing unit 31 and the injection unit 32 are typically significantly lower than in the outlet region of the injection unit, which significantly reduces the measurement effort required to determine the pressure difference.

In cyclic polymer processing methods, the plastic melt can flow continuously or discontinuously, and the flow rate varies over the duration of a cycle. In cyclic polymer processing methods, the pressure difference measured over time must be correlated with the flow rate relevant at the time of measurement. The measurement can be limited to partial times during which the flow rate and the associated pressure difference are within a range that is representative for the measurement. For an injection molding process, the duration can be the time it takes to inject the plastic melt into the molding tool or to fill an intermediate storage container.

FIG. 12 shows an example of the pressure difference Δp over time for a cyclic polymer processing method. The pressure difference Δp is shown on the y-axis, while the x-axis is the time axis (t). The highest measured flow rate and the highest measured pressure difference per cycle can be used as a basis for determining the viscosity measurement value for the cyclic polymer processing method. The highest measured flow rate and the highest measured pressure difference are considered to be an average value of the highest 0-10% of the measured values for the flow rate and the pressure difference. Alternatively, the measured flow rate and the measured pressure difference can be integrated over the duration of the measurement and an average value can be determined over at least one cycle. It has been shown that the inline viscosity measurement method according to the invention can be used to determine highly accurate and reproducible viscosity measurements. The viscosity measurements can comprise, for example, an intrinsic viscosity.

FIG. 13 shows an example of the pressure difference over time for a cyclic polymer processing method, which is configured as a discontinuous polymer processing method. In contrast to the cyclic polymer processing method, the plastic melt flows discontinuously in the discontinuous polymer processing method. When a plastic melt flows discontinuously, there is no flow movement for part of the cycle duration. For this part of the cycle duration, in which there is no flow movement, the flow rate drops to zero. Accordingly, the pressure difference also drops periodically to zero, as shown in the graph in FIG. 13.

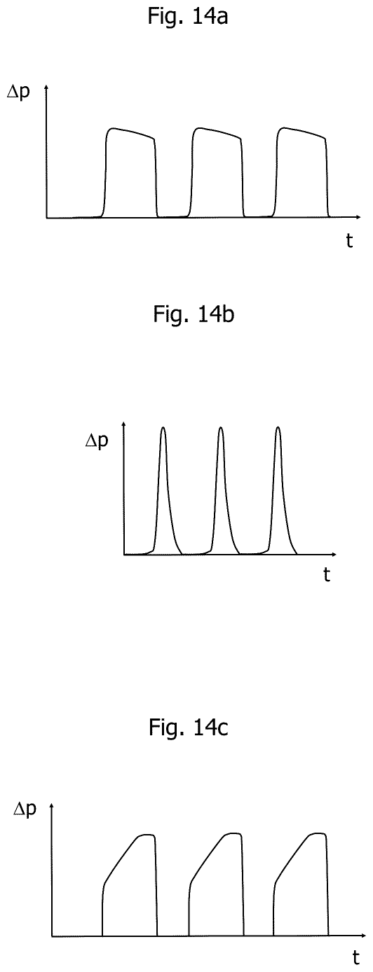

FIG. 14a, FIG. 14b, and FIG. 14c show further examples of time curves for the pressure difference for cyclic polymer processing methods, which are configured as discontinuous polymer processing methods. The cyclic polymer processing methods can also be configured as non-discontinuous cyclic polymer processing methods in accordance with FIG. 12.

### Examples

For an injection molding process, the following test results were obtained using the inline viscosity measurement method according to the invention, whereby a flow rate was measured in the measuring section that fluctuated between 0 kg/h and 75 kg/h. The total cycle time was 9 seconds. The melt temperature was 283 degrees Celsius.

In test A, a built-in element according to the invention was used, which is configured as a static mixer with crosswise arranged web elements, wherein the built-in element is configured as a group of web elements, wherein the at least one group of web elements extends in a first group plane and a second group plane, wherein the first group plane encloses a first angle to the longitudinal axis of the closed channel and the second group plane encloses a second angle to the longitudinal axis of the closed channel, wherein the first group plane intersects with the second group plane. The measuring section has a diameter of 50 mm and a length of 370 mm. The measured pressure difference is approximately 8.0 bar.

The measured viscosity is 645 Pa, with one measurement taken per cycle. For these measurements, the dispersion was +/−12 Pas over a period of 10 minutes, during which 66 cycles were recorded.

In Test B, a similar mixing element with a shorter length was used in accordance with the teaching of U.S. Pat. No. 6,412,337 B1. The measuring section has a diameter of 50 mm and a length of 75 mm. The measured pressure difference was approximately 1 bar and fluctuated. With regard to the measured viscosity, no meaningful measurement was possible in Test B. The viscosities fluctuated in a range from 50 to 600 Pas.

In test C, an built-in element with coils was used; this built-in element is also known as a Kenics mixer. The measuring section has a diameter of 25 mm and a length of 375 mm. The measured pressure difference is approximately 6.8 bar.

The measured viscosity is 653 Pas, with one measurement taken per cycle. For these measurements, the dispersion was +/−10 Pas over a period of 10 minutes, during which 75 cycles were recorded.

In Test D, a mixing element similar to that used in Test C was used, with a length corresponding to the teaching of U.S. Pat. No. 6,412,337 B1. The measuring section has a diameter of 25 mm and a length of 75 mm. The measured pressure difference was approximately 1.5 bar and fluctuated. With regard to the measured viscosity, no meaningful measurement was possible in Test D. The viscosities fluctuated in a range from 380 to 750 Pas.

It is obvious to a person skilled in the art that many other variants are possible in addition to the methods or devices described without deviating from the inventive concept. The subject matter of the invention is therefore not limited by the preceding description and is determined by the scope of protection defined by the claims. The broadest possible interpretation of the claims is decisive for the interpretation of the claims or the description. In particular, the terms “contain” or “include” should be interpreted as referring to elements, components, or steps in a non-exclusive sense, implying that the elements, components, or steps may be present or may be used, and that they may be combined with other elements, components, or steps that are not explicitly mentioned. If the claims refer to an element or component from a group that may consist of A, B, C to N elements or components, this wording shall be interpreted in such a way that only a single element of this group is required, and not a combination of A and N, B and N, or any other combination of two or more elements or components of this group.

What is claimed is:

1. A cyclic polymer processing method comprising an inline viscosity measurement method for determining a viscosity measurement value of a fluid polymer stream, wherein the fluid polymer stream flows through a measuring section arranged in a closed channel, wherein the closed channel comprises a longitudinal axis, an inlet end and an outlet end, wherein the measuring section extends at least between the inlet end and the outlet end, wherein a static mixer is arranged in the measuring section, which contains at least one built-in element, wherein an inlet pressure upstream of the at least one built-in element is measured by an inlet pressure sensor so that an inlet pressure measurement value is obtained, and wherein an outlet pressure downstream of the at least one built-in element is measured by an outlet pressure sensor so that an outlet pressure measurement value is obtained, wherein the inlet pressure measurement value and the outlet pressure measurement value are converted by means of a transducer into measurement variables that can be processed by a computer unit, wherein the computer unit determines a pressure difference between the inlet pressure measurement value and the outlet pressure measurement value, wherein a flow rate of the fluid polymer stream is determined via a conveying device or a flow rate measuring device, wherein the viscosity measurement value is determined from the pressure difference of the fluid polymer stream and the flow rate of the fluid polymer stream by means of a calculation formula, wherein the fluid polymer stream is not a side stream with recirculation, so that the fluid polymer stream is mixed by means of the static mixer, wherein a maximum measured pressure difference during a measurement time per cycle is at least 5 bar.

2. The cyclic polymer processing method of claim 1, wherein a displaced volume is determined via a conveying speed of a conveyor screw, or the displaced volume is measured in an intermediate storage container, or the displaced volume is determined from a weight of a component manufactured in a cycle, and wherein a filling time for filling the intermediate storage container is measured, or an injection time is measured when injecting the fluid polymer stream into a molding tool, and wherein the flow rate is determined from the displaced volume and the filling time or the injection time.

3. The cyclic polymer processing method of claim 1, wherein the viscosity measurement value is determined between an extruder and an intermediate storage container.

4. The cyclic polymer processing method of claim 1, wherein an intrinsic viscosity is derived from the pressure difference.

5. The cyclic polymer processing method of claim 1, wherein the viscosity measurement value is controlled by an addition of at least one additive.

6. The cyclic polymer processing method of claim 1, wherein the measurement time per cycle is less than 10 seconds.

7. The cyclic polymer processing method of claim 1, wherein the at least one built-in element is configured as at least one group of web elements, wherein the at least one group of web elements extends in a first group plane and a second group plane, wherein the first group plane includes a first angle to the longitudinal axis of the closed channel and the second group plane includes a second angle to the longitudinal axis of the closed channel, wherein the first group plane intersects with the second group plane.

8. The cyclic polymer processing method of claim 7, wherein web elements of at least one group of web elements with a web element length LS protrude into the closed channel, wherein the web element length LS is at least 25% of a diameter DS of the closed channel.

9. The cyclic polymer processing method of claim 1, wherein a shear rate of 20 [1/s] up to and including 500 [1/s] is measured in the static mixer.

10. The cyclic polymer processing method of claim 1, wherein the viscosity measurement value is used to determine a signal that correlates with the viscosity measurement value, wherein a parameter that changes the viscosity measurement value of a polymer is controlled by means of a control method with the signal as an input variable.

11. The cyclic polymer processing method of claim 1, wherein the viscosity measurement value is configured as a process-independent viscosity measurement value.

12. The cyclic polymer processing method of claim 10, wherein the parameter comprises an element from the group consisting of a chain extension additive, a temperature of the fluid polymer stream, and an additive that contains water or can split off water.

13. The cyclic polymer processing method of claim 1, wherein a temperature sensor is used to determine a temperature of the fluid polymer stream.

14. The cyclic polymer processing method of claim 1, wherein the fluid polymer stream contains a polymer recyclate.

15. The cyclic polymer processing method of claim 1, wherein a polymer comprises at least one element from the group consisting of a polyester and a polyamide.
